(19) United States
(12) Patent Application Publication
(10) Pub. No.: US 2023/0409389 A1
(43) Pub. Date: Dec. 21, 2023

(54) AI OPERATION PROCESSING METHOD ON INPUT IMAGE AND CAMERA DEVICE USING THE SAME

(71) Applicant: HANWHA TECHWIN CO., LTD., Seongnam-si (KR)

(72) Inventors: Byoung Man AN, Seongnam-si (KR); Young Sang KWON, Seongnam-si (KR); Jin Hyuk CHOI, Seongnam-si (KR); Song Ho LEE, Seongnam-si (KR); In Geon YI, Seongnam-si (KR); Byeong Yeop HA, Seongnam-si (KR)

(73) Assignee: HANWHA TECHWIN CO., LTD., Seongnam-si (KR)

(21) Appl. No.: 18/092,447

(22) Filed: Jan. 3, 2023

(30) Foreign Application Priority Data
Jun. 17, 2022 (KR) 10-2022-0073872

(51) Int. Cl. G06F 9/48; G06F 11/30

(52) U.S. Cl. CPC G06F 9/4881; G06F 11/3024; G06F 11/3051

(57) ABSTRACT

A camera device provided with a processor and a memory storing instructions executable by the processor is provided. The camera device comprises an image sensor for capturing an image of a subject, an AI application for requesting an AI operation on the captured image, and performing video analysis on the captured image using a processing result of the AI operation according to the request, a plurality of AI sources embedded in the camera device, an NPU controller for monitoring a current resource of the plurality of AI sources according to the AI operation request, and processing an AI operation by at least some of the plurality of AI sources according to priorities of the plurality of AI sources, and an NPU driver for transmitting the AI operation request and a processing result of the AI operation between the AI application and the NPU controller.

This application claims priority from Korean Patent Application No. 10-2022-0073872, filed on Jun. 17, 2022, in the Korean Intellectual Property Office, and all the benefits accruing therefrom under 35 U.S.C. 119, the contents of which in their entirety are herein incorporated by reference.

### BACKGROUND

### 1. Field

The present disclosure relates to AI operation processing on an input image, and more particularly, to an apparatus and method for efficiently performing AI operation processing on an input image in a camera device equipped with a neural processing unit (NPU).

### 2. Description of the Related Art

GPU (graphic processing unit) is typically used in the implementation of the recently developed advanced AI technology. The original purpose of the GPU is to process computer graphics. GPUs are often used for AI because graphics processing and AI operations are performed in a similar manner. However, because the original purpose of the GPU is not AI operation, inefficiencies in cost and power consumption may occur.

GPUs and FPGAs have cost disadvantages aside from performance. They show decent performance in AI operations, but they are expensive and inefficient because it contains a number of functions that are not directly related to AI operations. Accordingly, there is a demand for the development of a processor exclusively for AI operation processing. One such a processor is a so-called neural processing unit (NPU). The NPU has an advantage in the overall operating performance of the required speed to transmit a large amount of data, which is essential in AI operation process, and has a high-speed data transmission structure design optimized for AI algorithm.

The basic architecture of NPU can be applied substantially in any application without any restrictions. However, the type or function of the API used by each manufacturer of the NPU is different, so a standardized data format among various NPUs does not exist.

In particular, video analytics (VA) technology used in surveillance cameras, which identifies objects from input images and extracts events to generate metadata, is in a very suitable environment for applying AI algorithms. In particular, recently, capturing a vast amount of image by a surveillance camera and extracting a specific object or event from it is a characteristic consistent with the properties of AI learning.

As such, although the NPU in the form of a system on chip (SoC) has been developed by various manufacturers in the surveillance camera, the NPU should inevitably be supported by software compatible with the NPU. Accordingly, when a plurality of camera devices manufactured by various manufacturers are used or the SoC of an existing camera device needs to be changed, a lot of time and costs are required.

Therefore, regardless of the type of various NPUs, it is necessary to develop a standardized method that selects the most suitable one among AI sources existing inside and outside the surveillance camera in real-time and processes the input image by adding an NPU controller implemented with a software program and hardware made on an open platform to provide compatibility.

### SUMMARY

The technical object to be achieved by the present disclosure is to provide a camera device having an interface and API of an open platform environment so that AI resources inside and outside the camera device capable of AI operation can be efficiently utilized for AI-based video analysis.

According to one aspect of the present disclosure, a camera device is provided with a processor and a memory storing instructions executable by the processor. The camera device comprises: an image sensor for capturing an image of a subject; an AI application for requesting an AI operation on the captured image, and performing video analysis on the captured image using a processing result of the AI operation according to the request; a plurality of AI sources embedded in the camera device; an NPU controller for monitoring a current resource of the plurality of AI sources according to the AI operation request, and processing an AI operation by at least some of the plurality of AI sources according to priorities of the plurality of AI sources; and an NPU driver for transmitting the AI operation request and a processing result of the AI operation between the AI application and the NPU controller, and converting a command between the AI application and the NPU controller to be compatible.

The camera device includes an uppermost application layer, a SW layer located below the application layer, and a HW layer located below the SW layer, wherein the AI application belongs to the application layer, the NPU driver belongs to the SW layer, and the plurality of AI sources and NPU controller belong to the HW layer.

The NPU controller monitors a current resource of an available AI source including the embedded plurality of AI sources and an AI source external to the camera device, and selects an AI source having the highest priority among AI sources, in which value of the monitored current resource is equal to or greater than a threshold value, and allows the selected AI source to process the AI operation

The NPU controller selects the AI source, monitors a current resource of the selected AI source, and selects an AI source having a next priority to the selected AI source in response to value of the current resource falling below the threshold value.

The NPU controller, after selecting the AI source, monitors a current resource of the selected AI source, and selects the selected AI source and an AI source having a next priority together in response to value of the current resource falling below the threshold value.

The plurality of embedded AI sources include at least an NPU, and further include one or more of a GPU, a DSP, and a CPU, and the external AI source includes at least one of a detachable external SoC and a cloud server.

Among the available AI sources above, NPU has the highest priority.

Priorities are assigned to NPUs, detachable external SoCs, cloud servers, GPUs, DSPs, and CPUs in order of decreasing priorities.

The NPU belong to a first group, the detachable external SoC and cloud server belong to a second group, and the GPU, DSP and CPU belong to a third group, wherein priorities are assigned to the first group, the second group, and the third group in order of decreasing priorities.

The NPU driver receives a plurality of APIs capable of controlling the plurality of AI sources from the NPU controller, and converts the plurality of APIs into an expanded API including at least the plurality of APIs, wherein the AI application requests an AI operation using the expanded API.

The plurality of APIs include an API of an operating system and an API of a SDK.

The AI application transmits an AI learning model to an NPU controller, and the NPU controller provides the transmitted learning model to the selected AI source.

The NPU controller provides the AI operation request and a video captured by an image sensor to the selected AI source for the AI operation processing by the selected AI source.

The NPU controller, after converting properties of the captured video into properties supported by the selected AI source, provides the converted properties of the video to the AI source, wherein the properties of the video includes at least one of three-dimensional color space, resolution, frame rate, bit rate, and color depth.

The NPU controller, after receiving a processing result of the AI operation from the selected AI source, determines compatibility of a data format representing the processing result of the AI operation, transmits a data packet obtained by processing the data format and then packetizing to the NPU driver when there is no compatibility as a result of the determination, transmits a data packet obtained by packetizing without processing the data format to the NPU driver when there is compatibility as a result of the determination.

The data packet includes a header and a payload, and the header includes an AI identifier indicating that it is a data packet having a processing result of the AI operation.

The payload includes a field indicating a sequence of a video frame, a field indicating a time when the video frame was created, a field indicating a type of object identified within the video frame, a field indicating a probability that the identified object is correct, and a field indicating a position of the identified object within a video frame.

According to another aspect, there is provided a method for processing an AI operation, wherein, in a camera device provided with a processor and a memory storing instructions executable by the processor, the method is performed by the instructions according to control of the processor, the method including: capturing an image of a subject; requesting an AI operation on the captured image; monitoring a current resource of an available AI source including a plurality of AI sources embedded in the camera device and an AI source external to the camera device according to the AI operation request; processing an AI operation by at least some of the available AI source according to priorities of the available AI sources and an idle amount of the current resource; and performing video analysis on the captured image by using a processing result of the AI operation.

The processing the AI operation includes, monitoring a current resource of an available AI source including the embedded plurality of AI sources and an AI source external to the camera device; and selecting an AI source having the highest priority from among AI sources, in which value of the monitored current resource is equal to or greater than a threshold value.

The processing the AI operation includes, after selecting the AI source, monitoring a current resource of the selected AI source and selecting an AI source having a next priority to the selected AI source in response to value of the current resource falling below the threshold value.

According to the present disclosure, there is an advantage in that it is possible to enhance product competitiveness of a surveillance camera device by providing an expanded API for an NPU controller and an open platform to be compatible in various SoC environments.

In addition, according to the present disclosure, there is an advantage that low cost and high efficiency of AI operation processing can be achieved by processing an optimal AI operation for the input image using the AI source most suitable for the current situation in various SoC environments.

### BRIEF DESCRIPTION OF THE DRAWINGS

These and/or other aspects will become apparent and more readily appreciated from the following description, taken in conjunction with the accompanying drawings in which:

FIG. 1 is a diagram showing the configuration of an image surveillance system of the present disclosure;

FIG. 2 is a block diagram illustrating the configuration of a camera device the present disclosure;

FIG. 3 is a block diagram showing the configuration of the NPU controller included in the camera device of FIG. 2 in detail;

FIG. 4 is a block diagram illustrating details of the configuration of the AI data processing unit included in the NPU controller of FIG. 3;

FIG. 5 is a diagram illustrating the configuration of a data packet transmitted to an upper layer by an AI data processing unit;

FIG. 6 is a diagram showing an implementation of a computing device of the camera device of FIG. 2;

FIG. 7 is a flowchart schematically illustrating an AI operation processing method performed by a camera device of the present disclosure; and

FIG. 8 is a flowchart illustrating specific steps performed by the AI application and the NPU controller.

### DETAILED DESCRIPTION

Advantages and features of the disclosure and methods to achieve them will become apparent from the descriptions below with reference to the accompanying drawings. However, the inventive concept is not limited to examples disclosed herein but may be implemented in various ways. The examples are provided for making the disclosure of the inventive concept thorough and for fully conveying the scope of the inventive concept to those skilled in the art. It is to be noted that the scope of the disclosure is defined only by the claims. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustration rather than limiting the present disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

Hereinafter, the present disclosure will be described in detail with reference to the accompanying drawings.

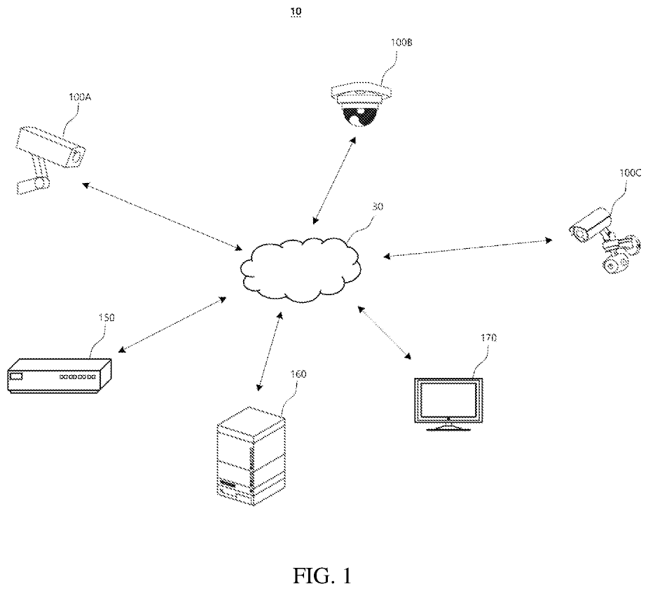

FIG. 1 is a diagram showing the configuration of an image surveillance system 10 according to the present disclosure. Referring to FIG. 1, the system 10 may comprise a plurality of camera devices 100: 100A, 100B, and 100C connected to each other through a network 30, a network video recorder (NVR) 150, a video management system (VMS) 160 and a user terminal device 170.

The camera devices 100A, 100B, and 100C have a function of capturing an image and a function of processing an AI operation. In the present disclosure, an image is used to encompass a still picture and a moving picture. The moving picture is also generally referred to as a video.

Video analytics (VA) may be performed on the images captured by the camera devices 100A, 100B, and 100C and the processing result of the AI operation. The metadata obtained through the VA may be stored in the network video recorder 150.

According to a user's search request, the video management system 160 may search for an image, among the stored images by using the metadata, for an image in which an event has occurred, and may take an action (alarm, object tracking, etc.) corresponding to the event.

The user terminal device 170 may be implemented by a personal computer, a mobile terminal, or the like, and may be connected to the camera device 100, the network video recorder 150, the video management system 160, and the like through the network 30.

As described above, the camera devices 100A, 100B, and 100C may perform VA through AI operation, and for this purpose, various hardware (SoC: system on chip) and software-based AI processing functions are provided in the camera devices. However, because a unique SoC may be used by each manufacturer of the camera device (100A, 100B, and 100C), the SoC may not be directly compatible with various software-based AI applications. And thus, it can be a hassle to load a dedicated AI application for each SoC.

Therefore, in the present disclosure, the camera device 100 converts a command function for AI processing, for example, an API (application programming interface), in a software layer in an open platform environment, to make the command function compatible. In the hardware side, a NPU controller is added to make it compatible to use the same AI application in various SoC environments.

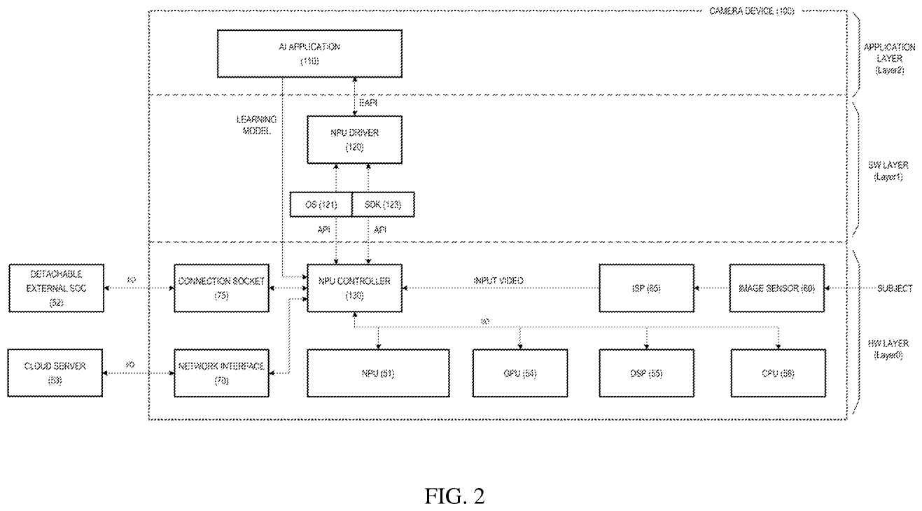

FIG. 2 is a block diagram illustrating a configuration of a camera device 100 according to the present disclosure.

As shown, the camera device 100 may comprise an uppermost application layer (Layer2), a SW layer (Layer1) located below the application layer (Layer2), and an HW layer (Layer0) located below the SW layer (Layer1).

Here, the AI application 110 belongs to the application layer (Layer2), the NPU driver 120 belongs to the SW layer (Layer 1), and a plurality of AI sources 51, 54, 55 and 56 embedded in the camera device 100 and the NPU controller 130 belong to the HW layer (Layer0).

The controlling unit or CPU 56 serves as a controller for controlling operations of other components of the camera device 100. In addition, the memory (not shown) is a storage medium for storing results performed by the CPU 56 or data necessary for the operation of the CPU 150, and may be implemented by a volatile memory or a non-volatile memory.

First, looking at the HW layer (Layer0), the image sensor 60 captures an image of an external subject. The image sensor 60 may be implemented by a known imaging device such as CCD or CMOS, and outputs digital values of the pixels included in the captured image.

An image signal processor (ISP) 65 may pre-process the captured image before storing it. The pre-processing may include image processing such as white balance, gamma adjustment, and up/down sampling. The image processed by the ISP 65 is provided to the NPU controller 130 as an input video.

In addition, a plurality of AI sources 51, 54, 55, 56 are embedded in the HW layer (Layer0), and each AI source 51, 54, 55, 56 is connected with the NPU controller 130 for communication. The embedded AI sources 51, 54, 55, 56 may be SoCs that are included in the camera device 100 itself and have a function to process the AI operation, and may comprise a neural processing unit (NPU) 51 and a GPU (graphic processing unit) 54, a digital signal processor (DSP) 55, and a central processing unit (CPU) 56.

Although computer graphics processing is the original purpose of the GPU 54, GPUs are used for AI operation processing because graphics processing and AI operation are performed in a similar manner. For example, Nvidia's GPU can process AI operation using CUDA, and GPUs from other manufacturers can process AI operations with their own API.

On the other hand, the purpose of NPU 51 is only AI operations, so the versatility is lower than that of the GPU, but the processing speed of AI operations is quite high because NPU is a chip for processing AI operations only. However, it is difficult for the NPU 51 to learn other AI algorithms due to such low versatility. This is because the NPU 51 uses hardware to implement the neural network of the AI algorithm's deep learning network. Therefore, NPU 51 might consume more time and cost to implement an algorithm with a different structure. However, in its original use, the NPU 51 shows high efficiency compared to the GPU 54. Manufacturers of such NPU 51 include ARM, Samsung Electronics, Apple, Qualcomm, Huawei, and the like.

On the other hand, by expanding from the embedded plurality of AI sources 51, 54, 55, 56, the AI sources 52, 53 which are external to the camera device 100 can also be connected together to the NPU controller 130. It can be defined as “available AI sources 50” encompassing these embedded AI sources and external AI sources.

The detachable external SoC 52 is in the form of an AI source that can be directly connected to the camera device 100 in a wired/wireless manner through a connection socket 75, for example, a USB terminal. This kind of detachable external SoC 52 does not require communication through a separate network, it may be useful in an environment, in which the NPU 51 is not installed inside the camera device 100.

In addition, the cloud server 53 is installed in a large-scale data center, an edge server, a gateway, or the like, and is in the form of an AI source that can be connected to the camera device 100 through network communication. Accordingly, for connection with the cloud server 53, the camera device 100 may include a network interface 70 such as Ethernet or WLAN.

The SW layer (Layer1) exists above the HW layer (Layer0). In the SW layer (Layer1), an NPU driver 120, an operating system (OS) such as Windows, Android, and IOS, a software development kit (SDK) 123, and the like are installed.

In general, SDK 123 is a development tool that is generally distributed to use extensions of a hardware platform such as the NPU 51, the operating system 121, and a programming language. In the present disclosure, the SDK 123 is used for the extensions of the NPU 51. In general, an application programming interface (API) is included in the SDK 123 as well as the operating system 121. API is generally referred to as a contract between an information provider and an information user and comprises the content needed by consumers (calls) and content needed by producers (responses). These APIs make it easier for users to develop complex applications, debug as needed and add new features as needed.

The NPU driver 120 receives the API (Application Programming Interface), that can control the available AI sources 51, 52, 53, 54, 55, 56, from the NPU controller 130 in the form of SDK. And, the NPU 120 performs conversion between a plurality of APIs provided by the operating system 121 or the SDK 123 and an expanded API including at least the plurality of APIs. That is, the NPU controller 130 may convert an API, which is different for each manufacturer and which provides a variety of AI sources, into a standardized expanded API (EAPI) that can be used by the AI application 110 and transmit the EAPI from the AI application 110. Similarly, the EAPI received in response to the request by the AI application 110 may be converted into the form of the API defined in the AI sources and provided to the NPU controller 130.

In response to the request by the AI application 110 through the NPU driver 120, the NPU controller 130 instructs to select at least one of the available AI sources 50 to perform AI operation processing.

Specifically, the NPU driver 120 monitors the current resource of the available AI sources 50 which includes the AI sources 51, 54, 55, 56 embedded in the camera device 100 and the AI sources 52, 53 external to the camera device 100. The NPU driver 120 selects the AI source having the highest priority from among the AI sources, in which value of the monitored current resource is equal to or greater than the threshold value, and processes the AI operation by the selected AI source.

In addition, even after selecting the AI source, the NPU driver 120 may monitor the current resource of the selected AI source, and select the AI source having the next priority to the selected AI source when value of the current resource falls below the threshold value. Alternatively, the NPU driver 120 may select the selected AI source and the AI source having the next priority together when value of the current resource falls below the threshold value, and distributes the AI operation to the plurality of AI sources to process it.

Among these available AI sources 50, the NPU 51, which is capable of performing dedicated AI operation processing and is embedded in the camera device 100, has the highest priority (first group). Next, the detachable external SoC 52 and the cloud server 53 that are external to the camera device 100 but have a built-in dedicated NPU have the next priority (second group). Finally, the remaining SoCs embedded in the camera device 100, the GPU 54, DSP 55, and CPU 56, have the lowest priority (third group).

In accordance with the above priorities, the NPU controller 130 performs AI operation in the order of the highest AI operation processing capability among the AI sources, in which value of the current resource is guaranteed to be equal to or greater than the threshold value, and then when the resource situation changes, the NPU controller 130 allows the next priority AI source to perform the AI operation.

As such, priorities may be grouped into three groups, but also, priority of each individual AI source may be determined for the entire AI sources. For example, priorities are preferably assigned to NPU 51, the detachable external SoC 52, the cloud server 53, the GPU 54, the DSP 55, and the CPU 56 in order of decreasing priorities.

In addition, the application layer (Layer2), which is the uppermost layer, is located above the SW layer (Layer 1). AI application 110, located in the uppermost layer (Layer2), requests an AI operation on the image captured by the image sensor 60 to the NPU driver 120. As a result, the AI application 110 receives the processing result of the AI operation via the NPU controller 130 and the NPU driver 120. The AI application may perform video analytics on the captured image using the processing result of the AI operation received as a result of the above request. Such video analytics is a process of extracting objects and events such as people, animals, and cars from the input video to generate metadata matching the input video. When the pair comprising the input video and the metadata is generated as described above, object search and/or event search by the video management system 170 described above is possible.

On the other hand, for AI operation, it is necessary to provide a learning model in order to conduct repeated AI learning. Such a learning model (neural network model) is preferably generated in advance by the AI application 110 and provided to the selected AI source through the NPU controller 130. Otherwise, a process of securing a separate learning model using the input video is required. The process of securing a learning model for AI learning in advance is as follows.

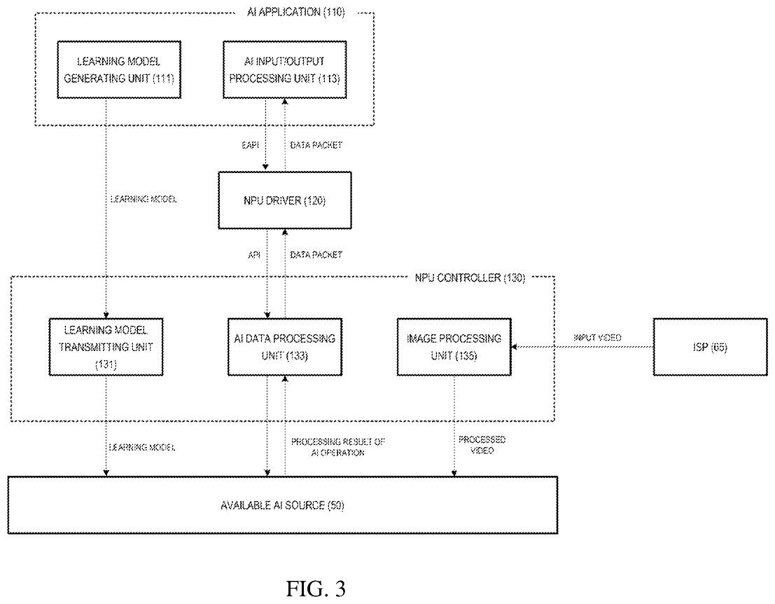

The learning model generating unit (111 of FIG. 3) uses raw data or training data to be input to the neural network model as learning data. The learning model generating unit learns to have a criterion for determining how the learning model classifies predetermined data by using the acquired training data. In this case, the learning model generating unit may train the neural network model through supervised learning by using at least a portion of the learning data to develop the criterion. Alternatively, the learning model generating unit may train a neural network model through unsupervised learning and discover a criterion by self-learning using the learning data without supervision. When the neural network model is trained, the learning model generating unit finally stores the learning model (neural network model) in the memory.

The AI application 110 transmits the generated AI learning model to the NPU controller 130, and the NPU controller 130 provides the transmitted learning model 131 to the selected AI source.

FIG. 3 is a block diagram illustrating details of the configuration of the AI application 110 and the NPU controller 130 included in the camera device 100 of FIG. 2.

The AI application 110 may include the AI input/output processing unit 113, and the NPU controller 130 may include a learning model transmitting unit 131, an AI data processing unit 133, and an image processing unit 135.

As described above, the learning model generated in advance by the learning model generating unit 111 is transmitted to the learning model transmitting unit 131 of the NPU controller 130. At this time, the learning model transmitting unit 131 may provide the learning model to the selected AI source as is, or convert it into an AI parameter (neural network parameter) that can be used in the AI source and provide the AI parameter to the AI source.

In addition, the image processing unit 135 processes the properties of the captured video into properties which are supported by the selected AI source, and then provides the processed video to the selected AI source. This video processing is a process of changing various image properties into image properties that are supported by the selected AI source, and the image properties include at least one of a three-dimensional color space (e.g., RGB, YCbCr, etc.), resolution, frame-rate, bitrate, and color depth (e.g., 256 colors, true color, etc.).

And, the AI data processing unit 133 transmits a commands downward or upward between the NPU driver 120 and the available AI sources 50. First, the AI input/output processing unit 113 of the AI application 110 transmits an expanded API (EAPI) to the NPU driver 120 in order to request an AI operation, and the NPU driver 120 converts the EAPI into an API supported by the available API sources 50 and transmits the converted API to the AI data processing unit 133. Thereafter, the AI data processing unit 133 provides the converted API to a selected AI source from among the available AI sources 50.

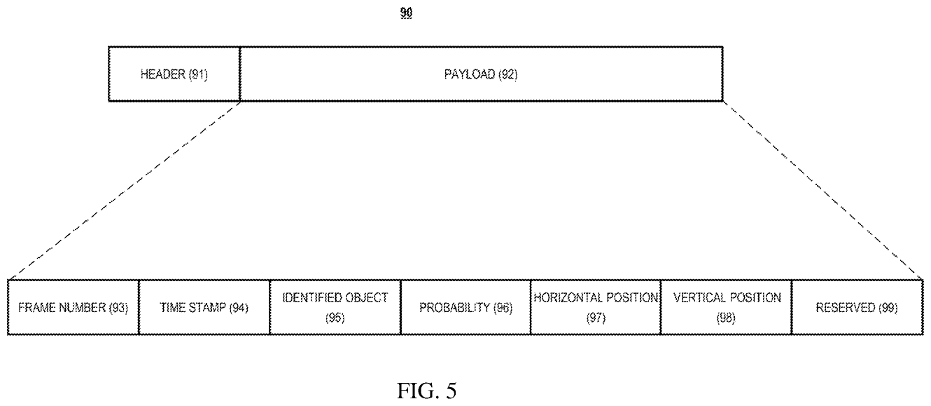

Conversely, the processing result obtained by performing the AI operation on the selected AI source is again provided to the AI data processing unit 133. At this time, the AI data processing unit 133 generates the processing result as a standardized data packet and provides it to the AI input/output processing unit 113 of the AI application 110 through the NPU driver 120. A specific example of such a data packet will be described later with reference to FIG. 5.

In short, the NPU controller 130 provides a learning model, an AI operation request (API form) and the processed video to the available AI sources 50, and receives the processing result of the AI operation from the available AI sources 50.

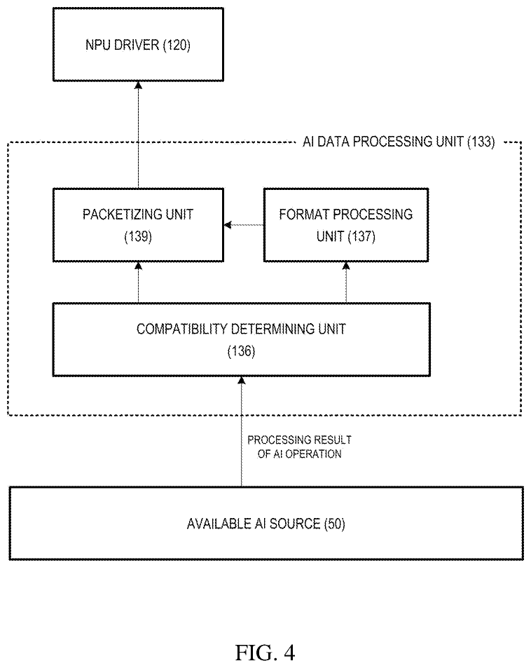

FIG. 4 is a block diagram illustrating details of the configuration of the AI data processing unit 133 included in the NPU controller 130 of FIG. 3.

As described above, the AI data processing unit 133 receives the processing result of the AI operation from the available AI sources 50 and provides it to the NPU driver 120 in the form of a standardized data packet. However, the compatibility determining unit 136 determines the compatibility of a data format representing the processing result of the AI operation after receiving the processing result of the AI operation from the selected AI source. If the determination results in no compatibility, the format processing unit 137 processes the processing result of the AI operation, and the packetizing unit 139 generates a data packet based on the processed data format. On the other hand, if is the determination results in compatibility, the data packet obtained by packetizing as it is without processing the data format may be transmitted to the NPU driver 120.

The compatibility described above means whether the processing result of the AI operation is in a format of data that the AI application 110 can recognize. In general, the processing results of AI operations depend on the AI source and are not standardized at all. For example, the number of data fields of the processing result provided by an AI source may itself be different from that of other AI sources, and the classification criteria or the number of classifications of objects or events in the processing result may be different. Also, the same object or event may be defined with a different name.

In view of this compatibility issue, the format processing unit 137 converts the processing result of the incompatible AI operation into compatible data and transmits the converted processing result to the packetizing unit 139, and the packetizing unit 139 always provides it to the NPU driver 120 in the form of a standardized data packet.

FIG. 5 is a diagram illustrating the configuration of a standardized data packet 90 transmitted to an upper layer by the AI data processing unit 133.

The data packet 90 basically comprises a header 91 and a payload 92. In this case, the header 91 includes an AI identifier (e.g., 0x0919) indicating that it is a data packet having a processing result of the AI operation. This identifier indicates that the data packet 90 includes the processing result of the AI operation, and is used to distinguish it from other types of various data packets.

Also, the payload 92 may comprise a plurality of standardized data fields. Specifically, the payload 92 includes a field 93 indicating the sequence of video frames, a field 94 indicating the time when the video frame was created, a field 95 indicating the type of object identified within the video frame, a field 96 indicating the probability that the identified object is correct, and a field 97, 98 indicating the position of the identified object within the video frame. Also, the payload 92 may further include a field 99 for recording additional data according to user definition.

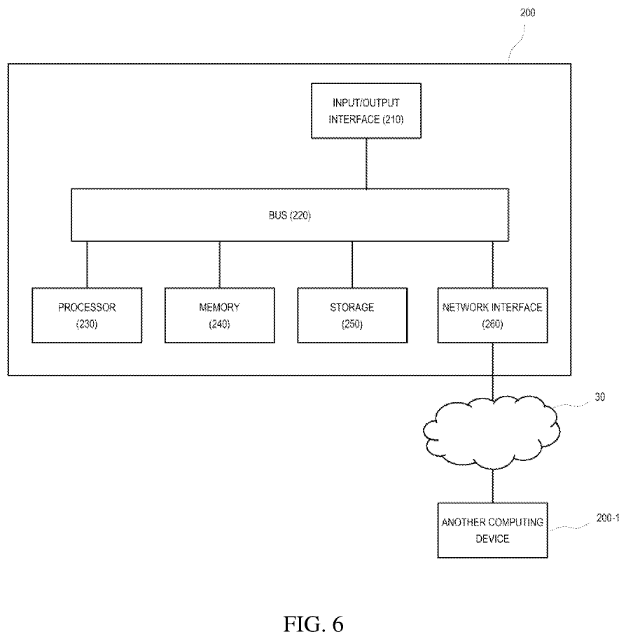

FIG. 6 is a diagram illustrating an implementation of the computing device 200 of the camera device 100 of FIG. 2.

The computing device 200 has a bus 220, a processor 230, a memory 240, a storage 250, an input/output interface 210, and a network interface 260. The bus 220 is a data transmission path for the processor 230, the memory 240, the storage 250, the input/output interface 210, and the network interface 260 to transmit and receive data to each other. However, a method of connecting the processors 230 to each other is not limited to a bus connection. The processor 230 is an operation processing unit such as a central processing unit (CPU), a graphics processing unit (GPU), or a digital signal processor (DSP). The memory 240 is a memory such as random access memory (RAM) or read only memory (ROM). The storage 250 is a storage device such as a hard disk, a solid state drive (SSD), or a memory card. Also, the storage 250 may be a memory such as a RAM or ROM.

The input/output interface 210 is an interface for connecting the computing device 200 and the input/output device. For example, a keyboard or mouse may be connected to the input/output interface 210.

The network interface 260 is an interface to connect the computing device 200 with an external device for communication in order to transmit and receive transport packets. The network interface 260 may be a network interface for connecting to a wired line or to a wireless line. For example, the computing device 200 may be connected to another computing device 200-1 through the network 30.

The storage 250 stores program modules implementing each function of the computing device 200. The processor 230 implements each function corresponding to the program module by executing each of these program modules. Here, the processor 230 may read the modules into the memory 240 and then execute the modules when executing the respective modules.

However, the hardware configuration of the computing device 200 is not limited to the configuration shown in FIG. 6. For example, each program module may be stored in the memory 240. In this case, the computing device 200 does not need to include the storage 250.

As such, the camera device 100 includes at least a processor 230 and a memory 240 for storing instructions executable by the processor 230. In particular, in the camera device 100 of FIG. 2, the application layer (Layer2) and the SW layer (Layer1) work by performing instructions including various functional blocks or steps included in the camera device 100 by the processor 230.

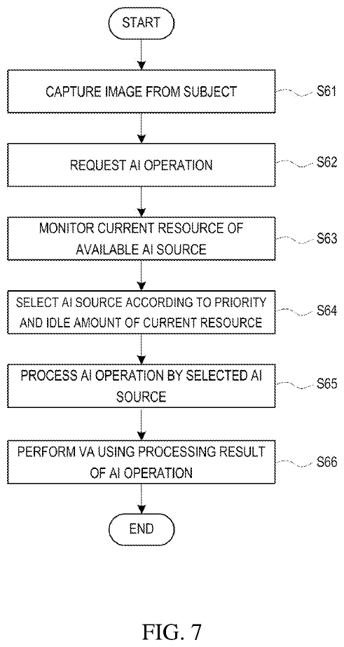

FIG. 7 is a flowchart schematically illustrating an AI operation processing method performed by the camera device 100 according to the present disclosure.

First, the image sensor 60 captures an image of a subject (S61).

Next, the AI application 110 requests the AI operation on the captured image to the NPU driver 120 (S62).

In response to the AI operation request, the NPU controller 130 monitors the current resource of the available AI sources 50 including a plurality of AI sources 51, 54, 55, 56 embedded in the camera device 100 and AI sources 52, 53 external to the camera device (S63).

In addition, the NPU controller 130 selects at least some of the available AI sources according to priorities of the available AI sources 50 and the idle amount of the current resource to process the AI operation (S64).

Accordingly, the selected AI source provides the processing result to the NPU controller 130 after performing the AI operation (S65). Thereafter, the AI application 110 performs video analysis (VA) on the captured image using the provided processing result of the AI operation (S66).

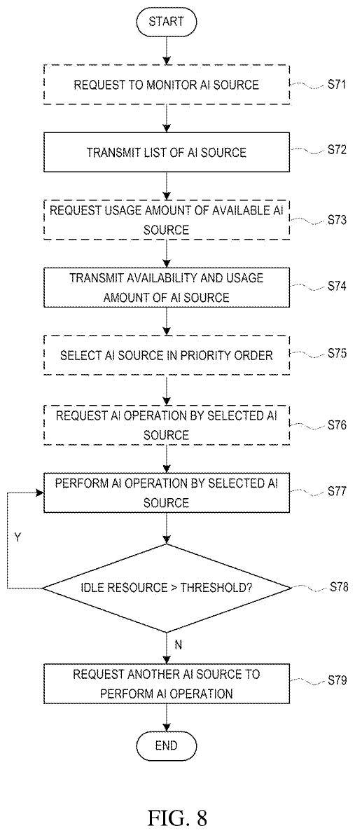

FIG. 8 is a flowchart illustrating specific steps performed by the AI application 110 and the NPU controller 130 in order to further refine the flowchart of FIG. 7. In FIG. 8, blocks indicated by the dotted lines indicate steps performed by the AI application 110, and blocks indicated by the solid lines indicate steps performed by the NPU controller 130.

First, the AI application 110 sends a request to the NPU controller 130 to monitor the AI sources (S71), and in response to the request, the NPU controller 130 transmits a list of available AI sources 50 to the AI application 110 (S72).

Next, the AI application 110 sends a request to the NPU controller 130 for the current resource or usage amount of the AI source (S73). In response to the request, the NPU controller 130 transmits the available AI source and the usage amount of the current resource to the AI application 110 (S74).

Thereafter, the AI application 110 sends a request to the NPU controller 130 to automatically or based on a user's command select an AI source in a predetermined priority order (S75), and sends a request to the NPU controller 130 for an AI operation to be performed by the selected AI source (S76). In response, the NPU controller 130 causes the selected AI source to perform the AI operation (S77).

After that, the NPU controller 130 periodically monitors the current idle resource of the selected AI source (S78). As a result, if value of the idle resource is equal to or greater than a predetermined threshold value (Y in S78), the AI operation by the selected AI source is continued (S77). Otherwise (N in S78), since the idle resources of the selected AI source are insufficient, the NPU controller 130 requests another AI source (preferably the next priority AI source) to perform an AI operation (S79). In this case, the entire AI operation may be transferred to another AI source, but it is also possible to distribute a subset of AI operations between the selected AI source and another AI source to process it together.

Many modifications and other aspects of the present disclosure will come to the mind of one skilled in the art having the benefit of the teachings presented in the foregoing descriptions and the associated drawings. Therefore, it is understood that the present disclosure is not to be limited to the specific examples disclosed, and that modifications and examples are intended to be included within the scope of the appended claims.

What is claimed is:

1. A camera device provided with a processor and a memory storing instructions executable by the processor comprising:
an image sensor for capturing an image of a subject;
an AI application for requesting an AI operation on the captured image, and performing video analysis on the captured image using a processing result of the AI operation according to the request;
a plurality of AI sources embedded in the camera device;
an NPU controller for monitoring a current resource of the plurality of AI sources according to the AI operation request, and processing an AI operation using at least some of the plurality of AI sources according to priorities of the plurality of AI sources; and
an NPU driver to transmit the AI operation request and processing result of the AI operation, between the AI application and the NPU controller, and to convert a command between the AI application and the NPU controller so that the command would be compatible.

2. The camera device of claim 1, wherein the camera device comprises an uppermost application layer, a SW layer located below the application layer, and a HW layer located below the SW layer,
wherein the AI application belongs to the application layer, the NPU driver belongs to the SW layer, and the plurality of AI sources and the NPU controller belong to the HW layer.

3. The camera device of claim 1, wherein the NPU controller,
monitors a current resource of available AI sources including the embedded plurality of AI sources and an external AI source, and
selects an AI source having the highest priority among AI sources, in which value of the monitored current resource is equal to or greater than a threshold value, and allows the selected AI source to process the AI operation.

4. The camera device of claim 3, wherein the NPU controller,
selects the AI source, monitors a current resource of the selected AI source, and selects an AI source having a next priority to the selected AI source in response to value of the current resource falling below the threshold value.

5. The camera device of claim 3, wherein the NPU controller,
after selecting the AI source, monitors a current resource of the selected AI source, and selects the selected AI source and an AI source having a next priority together in response to value of the current resource falling below the threshold value.

6. The camera device of claim 3, wherein the plurality of embedded AI sources includes at least an NPU, and further includes one or more of a GPU, a DSP, and a CPU, and the external AI source includes at least one of a detachable external SoC and a cloud server.

7. The camera device of claim 6, wherein the NPU has the highest priority among the available AI sources.

8. The camera device of claim 7, wherein priorities are assigned to NPU, a detachable external SoC, a cloud server, a GPU, a DSP, and a CPU in order of decreasing priorities.

9. The camera device of claim 7, wherein the NPU belongs to a first group, the detachable external SoC and cloud server belong to a second group, and the GPU, DSP and CPU belong to a third group,
wherein priorities are assigned to the first group, the second group, and the third group in order of decreasing priorities.

10. The camera device of claim 3, wherein the NPU driver receives a plurality of APIs capable of controlling the plurality of AI sources from the NPU controller, and converts the plurality of APIs into an expanded API including at least the plurality of APIs,
wherein the AI application requests an AI operation using the expanded API.

11. The camera device of claim 10, wherein the plurality of APIs include an API of an operating system and an API of a SDK.

12. The camera device of claim 10, wherein the AI application transmits an AI learning model to an NPU controller, and the NPU controller provides the transmitted learning model to the selected AI source.

13. The camera device of claim 3, wherein the NPU controller provides the AI operation request and a video captured by an image sensor to the selected AI source for the AI operation processing by the selected AI source.

14. The camera device of claim 13, wherein the NPU controller,
after converting properties of the captured video into properties supported by the selected AI source, provides the converted properties of the video to the AI source,
wherein the properties of the video includes at least one of three-dimensional color space, resolution, frame rate, bit rate, and color depth.

15. The camera device of claim 3, wherein the NPU controller is configured to,
after receiving a processing result of the AI operation from the selected AI source, determine compatibility of a data format representing the processing result of the AI operation,
determine that there is no compatibility of the data format and transmit a data packet, obtained by processing the data format and then packetizing it, to the NPU driver,
determine that there is compatibility of the data format and transmit a data packet, obtained by packetizing the data format without processing the data format, to the NPU driver.

16. The camera device of claim 1, wherein the data packet includes a header and a payload, and the header includes an AI identifier indicating that it is a data packet having a processing result of the AI operation.

17. The camera device of claim 16, wherein the payload includes a field indicating a sequence of a video frame, a field indicating a time when the video frame was created, a field indicating a type of object identified within the video frame, a field indicating a probability that the identified object is correct, and a field indicating a position of the identified object within a video frame.

18. A method for processing an AI operation, in a camera device provided with a processor and a memory storing instructions executable by the processor, wherein the method is performed by the instructions controlled by the processor and the method comprises:
capturing an image of a subject;
requesting an AI operation on the captured image;
monitoring a current resource of available AI sources including a plurality of AI sources embedded in the camera device and an AI source external to the camera device according to the AI operation request;
processing an AI operation by at least some of the available AI sources according to priorities of the available AI sources and an idle amount of the current resource; and
performing video analysis on the captured image by using a processing result of the AI operation.

19. The method of claim 18, wherein processing the AI operation comprises,
monitoring a current resource of available AI sources including the embedded plurality of AI sources and the AI source external to the camera device; and
selecting an AI source having the highest priority from among AI sources, in which value of the monitored current resource is equal to or greater than a threshold value.

20. The method of claim 19, wherein processing the AI operation comprises, after selecting the AI source, monitoring a current resource of the selected AI source and selecting an AI source having a next priority to the selected AI source in response to value of the current resource falling below the threshold value.
